(19) United States
(12) Patent Application Publication
(10) Pub. No.: US 2015/0194809 A1
(43) Pub. Date: Jul. 9, 2015

(54) Variable DC Power Supply and HART Adapter

(71) Applicant: Erick Mendoza, Fresno, CA (US)

(72) Inventor: Erick Mendoza, Fresno, CA (US)

(21) Appl. No.: 14/591,597

(22) Filed: Jan. 7, 2015

Related U.S. Application Data
(60) Provisional application No. 61/924,366, filed on Jan. 7, 2014.

(51) Int. Cl. H02J 1/00; H02J 4/00; H02J 7/00

(52) U.S. Cl. CPC H02J 1/00; H02J 7/0047; H02J 7/0042; H02J 4/00; H02J 2007/005

(57) ABSTRACT

A combination DC power source and HART adapter is provided. The present device has a first output mode, which is a conventional DC electrical output, and a second output mode, which modulates the DC output signal with a superimposed AC output signal, i.e. superimposes an analog signal on the digital signal, that conforms to a HART communications protocol. In the first output mode, the device acts as a DC power source with a variable, controllable output. In the second output mode, the device acts as a HART adapter for communicating with HART-enabled electronic devices. This mode can be used to troubleshoot and run diagnostics on HART-enabled electronic devices by simulating various error conditions, such as loss of DC power supply or erratic power fluctuation, in the field. The device combines the functionality of a DC power source with a HART adapter and is suitable for both field and non-field use.

### CROSS REFERENCE TO RELATED APPLICATION

This application claims the benefit of U.S. Provisional Application No. 61/924,366 filed on Jan. 7, 2014. The above identified patent application is herein incorporated by reference in its entirety to provide continuity of disclosure.

### FIELD OF THE INVENTION

The present invention relates to power supplies and communications protocols for instrumentation. More specifically, the present invention relates to DC power supplies having an adjustable output voltage and multiple output modes, wherein one of the output modes utilizes the Highway Addressable Remote Transducer (HART) protocol for communicating with HART-enabled electronic instrumentation.

### BACKGROUND OF THE INVENTION

Professionals in the automation and instrumentation fields, electronics hobbyists, and other such individuals are often forced to carry a substantial number of power adapters and other equipment with them when setting up, testing, and troubleshooting electronic devices in the field. Furthermore, such individuals need to utilize separate items for communicating with instrumentation enabled with the HART communications protocol. This forces these individuals to have a wide range of equipment on hand at all times, which can be cumbersome and difficult to manage. Therefore, there is a need in the prior art for a portable device that combines the functionality of a power source and an adapter for communicating with HART-enabled instrumentation for both field and non-field use.

### SUMMARY OF THE INVENTION

In view of the foregoing disadvantages inherent in the known types of DC power sources and HART adapters now present in the prior art, the present invention provides a combination variable DC power source and HART adapter apparatus wherein the same can be utilized for providing convenience for the user when powering devices for programming prior to installation and performing field trouble shooting. The present invention is a portable device that comprises a first output mode, which is a conventional DC electrical output, and a second output mode, which modulates the DC output signal with a superimposed AC output signal, i.e. superimposes an analog signal on the digital signal, that conforms to a HART communications protocol. In the first output mode, the device acts as a DC power source for electronic devices. The voltage output can be altered via a voltage selector circuit, which steps down the voltage of the internal power source. In the second output mode, the device acts as a HART adapter for communicating with HART-enabled electronic devices. This mode can be used to troubleshoot and run diagnostics on HART-enabled electronic devices by simulating various error conditions, such as loss of DC power supply or erratic power fluctuation, in the field. The present invention combines the functionality of a DC power source with a HART adapter into a single device that is suitable for both field and non-field use.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of the present invention.

FIG. 2 shows a circuit diagram of an exemplary embodiment of the present invention.

FIG. 3 shows a perspective view of the present invention.

### DETAILED DESCRIPTION OF THE INVENTION

Reference is made herein to the attached drawings. Like reference numerals are used throughout the drawings to depict like or similar elements of the variable DC power supply. For the purposes of presenting a brief and clear description of the present invention, the preferred embodiment will be discussed as used for powering devices for programming prior to installation and performing field trouble shooting. The figures are intended for representative purposes only and should not be considered to be limiting in any respect.

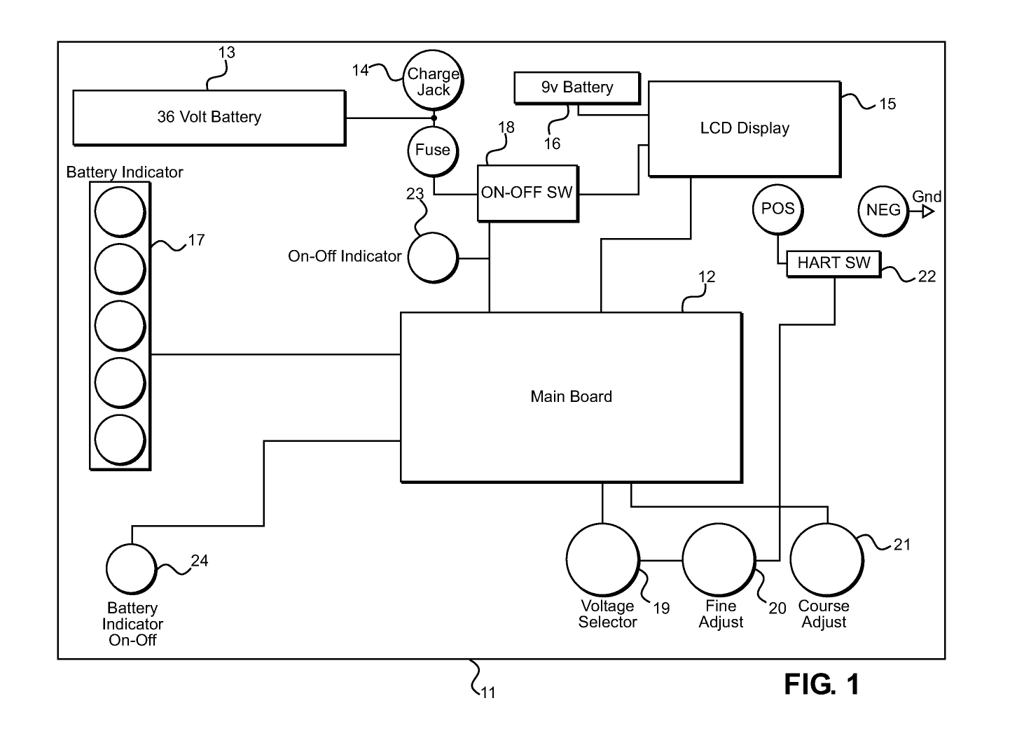

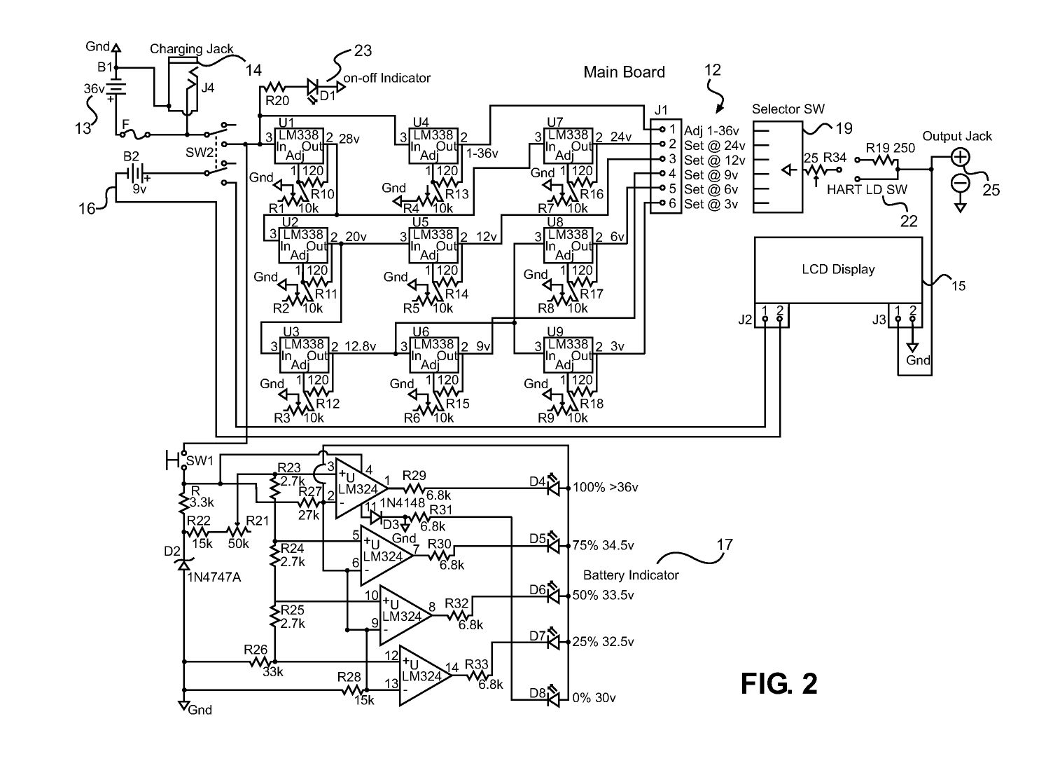

Referring now to FIGS. 1 and 2, there are shown a diagram of the present invention and a circuit diagram of an exemplary embodiment of the present invention. The present invention comprises a portable housing 11 containing a circuit 12, a power source 13, a display 15, a battery indicator 17, and an output 25. The circuit 12 is in electrical communication with the power source 13 and is adapted to output a number of preset DC voltages, as controlled by the voltage selector 19. In an exemplary embodiment of the present invention, the power source 13 comprises a 36 V battery and the voltage selector 19 comprises six different outputs comprising a first variable output having a selectable range 1.2 to 36 V and five set outputs of 24 V, 12 V, 9 V, 6 V, and 3 V. The present invention further comprises a mode selector 22 that is adapted to switch the present invention between a first output mode, which is a conventional DC electrical output, and a second output mode, which modulates the DC output signal with a superimposed AC output signal, i.e. superimposes an analog signal on the digital signal, that conforms to a HART communications protocol. HART is a bi-directional communications protocol, therefore this allows the present invention to transmit data to and receive data from the HART-enabled electronic device to which it is connected. The present invention is thus adapted to serve as both a transportable power source for powering electronic devices for programming prior to installation and as a means for field testing or troubleshooting HART-enabled electronic devices by simulating the loss of DC power, power fluctuations, and other such error conditions.

The output voltage selector 19 comprises a means for stepping down an input voltage from a power source 13, e.g. a battery, to one or more output voltages that are selectable by a user and a means for selecting the plurality of preset voltages disposed on the exterior of the housing 11. The depicted embodiment of the voltage selector 19 comprises a plurality of voltage regulators or other voltage-limiting devices connected in series to step down the input voltage from the power source 13 to the one or more selectable outputs voltages. The depicted embodiment of the present invention utilizes LM338 voltage regulators; however, no claim is made as to the precise voltage regulators or means of stepping down the input voltage. The present invention further comprises a fine adjustment knob 20 and a coarse adjustment knob 21 for tuning the preset output voltages of the voltage selector 19. The adjustment knobs 20, 21 allow users to alter the output voltage of the voltage selector 19 from the one or more preset output voltages to any voltage along the output range of the power source 13. In the exemplary depicted embodiment, the power source 13 comprises a 36 V battery that is capable of outputting a range of 1.2 V to 36 V.

The present invention further comprises a jack 14 disposed on the housing 11 that is in electrical communication with the power source 13. The jack 14 is adapted to accept any type of electrical connector so that the present invention may be connected to a variety of DC or AC external power sources. In one embodiment of the present invention, the power source 13 comprises a rechargeable battery and when an external power source is connected to the device via the jack 14, the external power source recharges the internal power source 13. The present invention further comprises a battery indicator 17 that is in electrical communication with the power source 13 and is adapted to display the remaining charge, i.e. battery life, thereof. An alternative embodiment of the present invention further comprises a battery indicator power switch 24 for turning the battery indicator 17 on or off. The battery indicator 17 comprises a means for determining the remaining charge of the power source 13 and selectively activating a means for displaying the remaining charge. In the depicted embodiment of the present invention, the battery indicator 17 comprises a plurality of operational amplifiers that are connected to a plurality of lights disposed on the exterior of the housing 11 that selectively activate the lights such that the number of illuminated lights is proportional to the remaining charge of the power source 13. The depicted embodiment utilizes LM324 operational amplifiers; however, no claim is made as to the precise operational amplifiers or means by which the battery indicatory 17 determines the remaining charge within the power source 13.

The mode selector 22 allows the present invention to be switched between a standard operational mode in which it acts as a variable DC power source and a HART communications mode that allows the present invention to send commands to and receive information from HART-enabled electronic devices. The mode selector 22 comprises a switch that selectively applies a defined load in the output circuitry that, when activated, superimposes an AC signal over the output DC signal. The modulated signal conforms to HART communication protocol standards, thereby allowing the present invention to communicate with HART-enabled devices, such as ABB Totalflow products designed for industrial remote monitoring and flow measurement; digital cellular products used for remote communications, such as Honeywell communicators; Schneider Electric SCADA pack equipment; and Emerson Rosemount products, such as differential transmitters and SMV flow transmitters. The present inventions comprises embodiments having a single predetermined load and embodiments having multiple different loads that are selectable by the user to provide alternative HART output signals. Furthermore, many devices that are not HART-enabled nonetheless benefit from having the wide range of available voltages to power, program, simulate, and troubleshoot that is provided by the present invention.

The present invention further comprises an output jack 25 to which electronic devices can be connected. When the device is in its standard operational mode, it acts as a DC power source with an adjustable voltage output for powering any type of suitable electronic device connected thereto via the output jack 25. When the device is in its HART communications mode, it allows the present invention to perform a wide range of tasks for HART-enabled devices that are connected thereto via the output jack 25, including preparing these devices for initial installation, performing complete system checks, and troubleshooting by simulating a wide variety of error conditions.

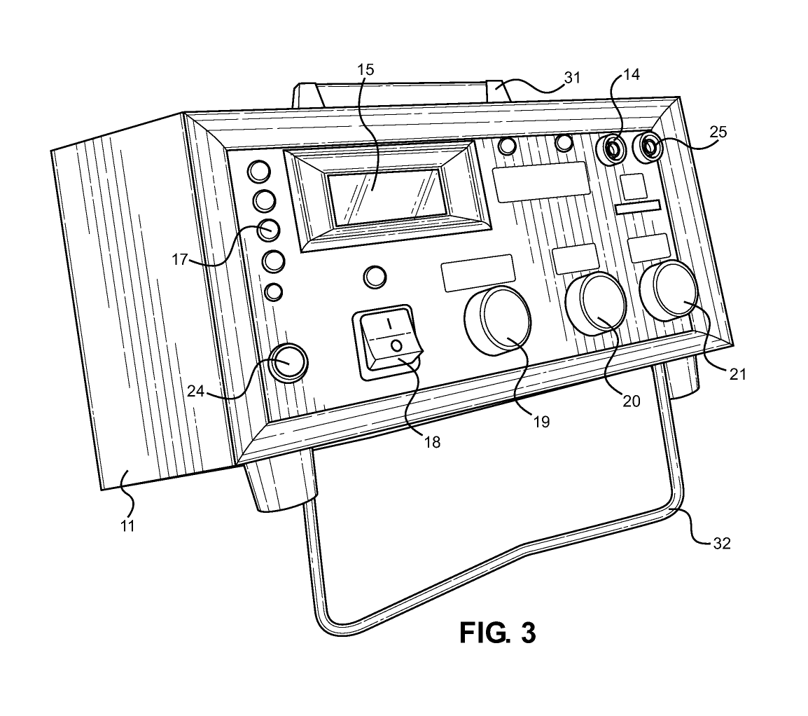

Referring now to FIG. 3, there is shown a perspective view of the present invention. The present invention is adapted for both field and non-field use. As such, the present invention is comprises a portable, compact housing 11 containing all of the electronic components, a display 15 disposed on the exterior of the housing for viewing voltage output levels and communication features when placed in the HART communications mode, a handle 31 extending from the upper surface of the housing 11, and a kickstand 32 or other such means of supporting the present invention in a static position. The display 15 is preferably an LCD display screen. The face of the housing 11 further comprises a battery indicator 17, a battery indicator power switch 24, voltage selector 19, a fine adjustment knob 20, a coarse adjustment knob 21, an output jack 25, a power switch 18, a power indicator 23 that illuminates when the device is activated, and a mode selector 22 for switching the present invention between the DC power supply mode and the HART communications mode.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A variable DC power supply, comprising:
a power source;
a circuit in electrical communication with the battery that is adapted to output an output voltage;
a voltage selector for selecting the output voltage from one or more pre-set voltages;
a mode selector for selecting either a first output mode or a second output mode;
wherein the second output mode creates a load in the circuit to modulate the output voltage with a superimposed AC signal that conforms to a Highway Addressable Remote Transducer (HART) protocol.

2) The variable DC power supply of claim 1, further comprising:
a battery indicator circuit adapted to determine a level of charge in the power source.

3) The variable DC power supply of claim 1, wherein the one or more pre-set voltages comprise a first voltage, a second voltage, a third voltage, a fourth voltage, and a fifth voltage.

4) The variable DC power supply of claim 1, wherein the power source comprises a rechargeable battery.

5) The variable DC power supply of claim 4, further comprising a charging jack.

6) The variable DC power supply of claim 1, further comprising:
one or more tuning knobs adapted to alter the one or more pre-set voltages.

7) The variable DC power supply of claim 1, further comprising:
a housing comprising a handle and a kickstand.
